(19) United States
(12) Patent Application Publication
(10) Pub. No.: US 2011/0289914 A1
(43) Pub. Date: Dec. 1, 2011

(54) UPSTREAM EGR RESTRICTION

(75) Inventor: Homa Afjeh, Dunlap, IL (US)

(73) Assignee: Caterpillar Inc., Peoria, IL (US)

(21) Appl. No.: 12/789,567

(22) Filed: May 28, 2010

(51) Int. Cl. F02D 23/00; F02B 47/08; F02D 13/04; F02M 25/07; F01N 3/023

(52) U.S. Cl. 60/602; 123/568.12; 60/295; 123/321; 123/568.21

(57) ABSTRACT

A power system comprising an engine that produces exhaust and includes an exhaust gas recirculation (EGR) system. The EGR system includes an EGR conduit routing an exhaust flow back to the engine, a restriction valve disposed in the EGR conduit, and a control valve disposed in the EGR conduit in series with the restriction valve.

### TECHNICAL FIELD

The present disclosure relates to engine exhaust gas recirculation systems, and more particularly to controlling flow in engine exhaust gas recirculation systems during exhaust particulate filter regeneration or engine braking operations.

### BACKGROUND

Engine systems often an include exhaust gas recirculation (EGR) system to reduce harmful emissions. EGR valves are used to control the flow through these EGR systems. U.S. Pat. No. 6,347,619 discloses an EGR system using a secondary exhaust valve in the cylinder head and two EGR valves. The first EGR valve is disposed in an EGR line with a cooler and the second EGR valve is disposed in a separate parallel EGR line without a cooler.

### SUMMARY

In one aspect, a power system is disclosed comprising an engine that produces exhaust and includes an exhaust gas recirculation (EGR) system. The EGR system includes an EGR conduit routing an exhaust flow back to the engine, a restriction valve disposed in the EGR conduit, and a control valve disposed in the EGR conduit in series with the restriction valve.

In another aspect, a method of operating a power system is disclosed. The method includes actuating a control valve disposed in an exhaust gas recirculation (EGR) conduit that routes an exhaust flow from an engine back to the engine during a standard operating mode and actuating a restriction valve disposed in the EGR conduit upstream of the control valve to stop the flow through the EGR conduit during engine braking.

In yet another aspect, a method of operating a power system is disclosed. The method includes actuating a control valve disposed in an exhaust gas recirculation (EGR) conduit that routes an exhaust flow from an engine back to the engine during a standard operating mode and actuating a restriction valve disposed in the EGR conduit upstream of the control valve to stop the flow through the EGR conduit during regeneration of an exhaust filter.

Other features and aspects of this disclosure will be apparent from the following description and the accompanying drawings.

### BRIEF DESCRIPTION OF THE DRAWINGS

FIG. 1 is a diagrammatic view of a power system with an EGR system.

FIG. 2 is a diagrammatic view of a power system with an alternative EGR system.

FIG. 3 is a diagrammatic view of a power system with another alternative EGR system.

FIG. 4 is a diagrammatic view of an engine with a compression release braking system.

FIG. 5 is a graph showing housing pressures in the compression release brake system.

FIG. 6 is a flow diagram of a regeneration operation.

FIG. 7 is a flow diagram of an engine braking operation.

### DETAILED DESCRIPTION

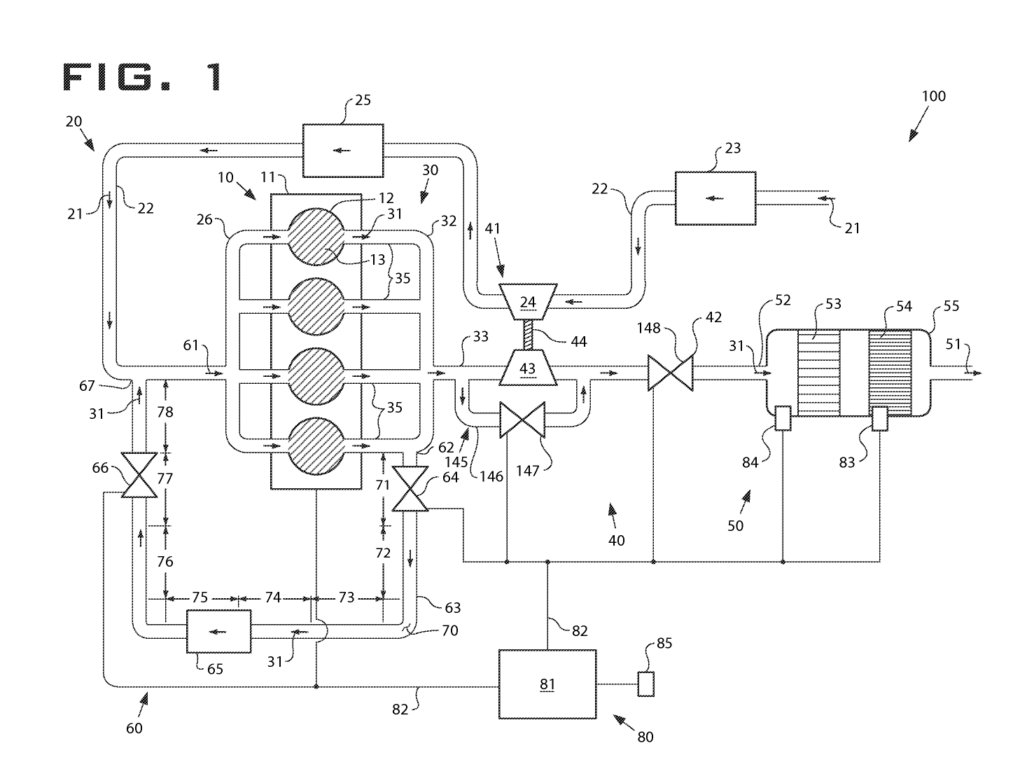

FIGS. 1, 2, and 3 illustrate three different exemplary power systems 100, 200, and 300 equipped with different exhaust gas recirculation (EGR) systems. Each of the power systems 100, 200, and 300 shown include an engine 10, an air intake system 20, an exhaust system 30, turbo and backpressure system 40, an aftertreatment system 50, an EGR system 60, and a control system 80. The power systems may also include other features not shown, such as fuel systems, sensors, cooling systems, peripheries, drivetrain components, etc.

The engine 10 includes a block 11, cylinders 12, and pistons 13. The pistons 13 reciprocate within the cylinder 12 to drive a crankshaft. The engine 10 may be any type of engine (internal combustion, gas, diesel, gaseous fuel, natural gas, propane, etc.), may be of any size, with any number of cylinders, and in any configuration (“V,” in-line, radial, etc.). The engine 10 may be used to power any machine or other device, including on-highway trucks or vehicles, off-highway trucks or machines, earth moving equipment, generators, aerospace applications, locomotive applications, marine applications, pumps, stationary equipment, or other engine powered applications.

The air intake system 20 delivers fresh intake air 21 to the engine 10. The air intake system 20 includes an intake conduit 22, air cleaner 23, compressor 24, intake air cooler 25, and intake manifold 26. The fresh intake air 21 is sucked in through the intake conduit 22 and passes into the cylinder 12. The intake air 21 is first drawn through the air cleaner 23, is then compressed by the compressor 24, and next cooled by the intake air cooler 25. The fresh air 21 is then delivered to the engine 10 via the intake manifold 26. The engine's 10 intake valves associated with each cylinder 12 may be used to deliver the air to the cylinders 12 for combustion. The air intake system 20 may also include an intake throttle valve to control the flow of intake air 21 and an intake air heater to warm the intake air 21.

The exhaust system 30 routes raw exhaust 31 from the engine 10 to the turbo and backpressure system 40 and EGR system 60. The exhaust system 30 includes an upstream exhaust manifold 32 and a downstream exhaust manifold 33. The upstream exhaust manifold 32 is connected directly to the engine 10 and may include individual legs 35 that receive the raw exhaust 31 from the engine's 10 exhaust valves associated with each individual cylinder 12. The downstream exhaust manifold 33 receives the raw exhaust 31 from the upstream exhaust manifold 32 and delivers the raw exhaust 31 to the turbo and backpressure system 40.

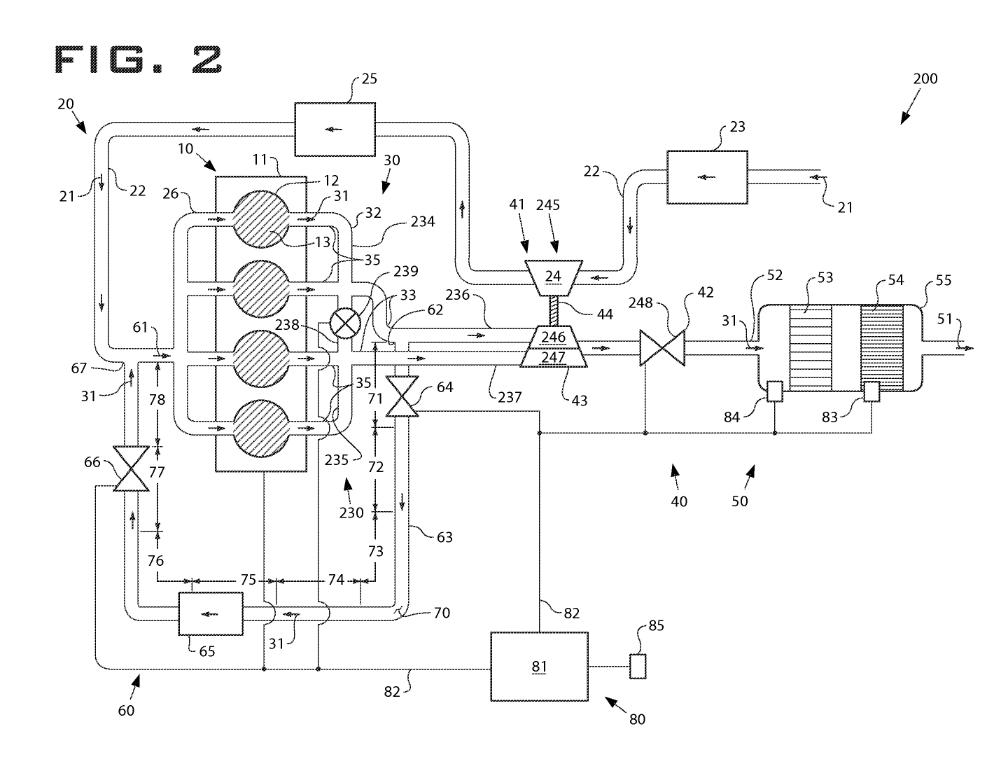

FIG. 2 shows the exhaust system 30 of the power system 200 including a split exhaust system 230. The split exhaust system 230 includes split, first and second upstream exhaust manifolds 234 and 235 that feed into split, first and second downstream exhaust manifolds 236 and 237. Each of the first and second upstream exhaust manifolds 234 and 235 receive raw exhaust 31 from a separate group of one or more cylinders 12.

The first and second upstream exhaust manifolds 234 and 235 or the first and second downstream exhaust manifolds 236 and 237 may be connected by a balance conduit 238 with a balance valve 239 disposed therein.

The turbo and backpressure system 40 routes raw exhaust 31 from the exhaust system 30 to the aftertreatment system 50. The turbo and backpressure system 40 includes a turbo 41 and a backpressure restriction 42. The turbo 41 includes the compressor 24, a turbine 43, and a turbo shaft 44. The turbine 43 is rotationally connected to the compressor 24 via the turbo shaft 44. Some embodiments may also include one or more additional turbos in series or in parallel. The backpressure restriction 42 is a controllable restriction within or downstream of the turbo 41.

The raw exhaust 31 is expunged from the engine 10 via the engine's 10 exhaust valves and is routed through the upstream exhaust manifold 32 and downstream exhaust manifold 33 to the turbine 43. The hot raw exhaust 31 drives the turbine 43, which drives the compressor 24, and compresses the fresh intake air 21.

FIG. 1 shows the first power system 100 including a wastegate 145. The wastegate 145 includes a wastegate conduit 146 and a wastegate valve 147. The wastegate conduit 146 connects from upstream to downstream of the turbine 43 and the wastegate valve 147 is disposed inside the wastegate conduit 146. The second and third power systems 200 and 300 may also include a wastegate 145. In some embodiments the wastegate 145 may not be needed or included. The wastegate conduit 146 allows the raw exhaust 31 to by-pass the turbine 43 when the wastegate valve 147 is opened. The wastegate 145 is controlled to regulate turbo 41 boost pressure and the wastegate valve 147 may be configured to open once a threshold boost pressure is reached.

FIG. 2 shows the second power system 200 including an asymmetric turbo 245. The turbine 43 of the asymmetric turbo 245 includes a first and second volute 246 and 247 that are different sized. The first downstream exhaust manifold 236 delivers raw exhaust 31 to the first volute 246 and the second downstream exhaust manifold 237 delivers raw exhaust 31 to the second volute 247. The first volute 246 is smaller than the second volute 247 to create higher backpressure in the first upstream exhaust manifold 234 and first downstream exhaust manifolds 236 than in the second upstream exhaust manifold 235 and second downstream exhaust manifolds 237 absent operation of the balance valve 239.

FIGS. 1 and 2 show the first and second power systems 100 and 200 including a backpressure valve 148 and 248 acting as the backpressure restriction 42. The backpressure valve 148 and 248 may be disposed in the exhaust conduit downstream of the turbo 41. The backpressure valve 148 and 248 may be a butterfly valve or another controllable restriction downstream of the turbo 41. The backpressure valve 148 and 248 may also be upstream of the aftertreatment system 50. The backpressure valve 148 and 248 may be located as close as possible to the outlet of the turbine 43 to improve performance.

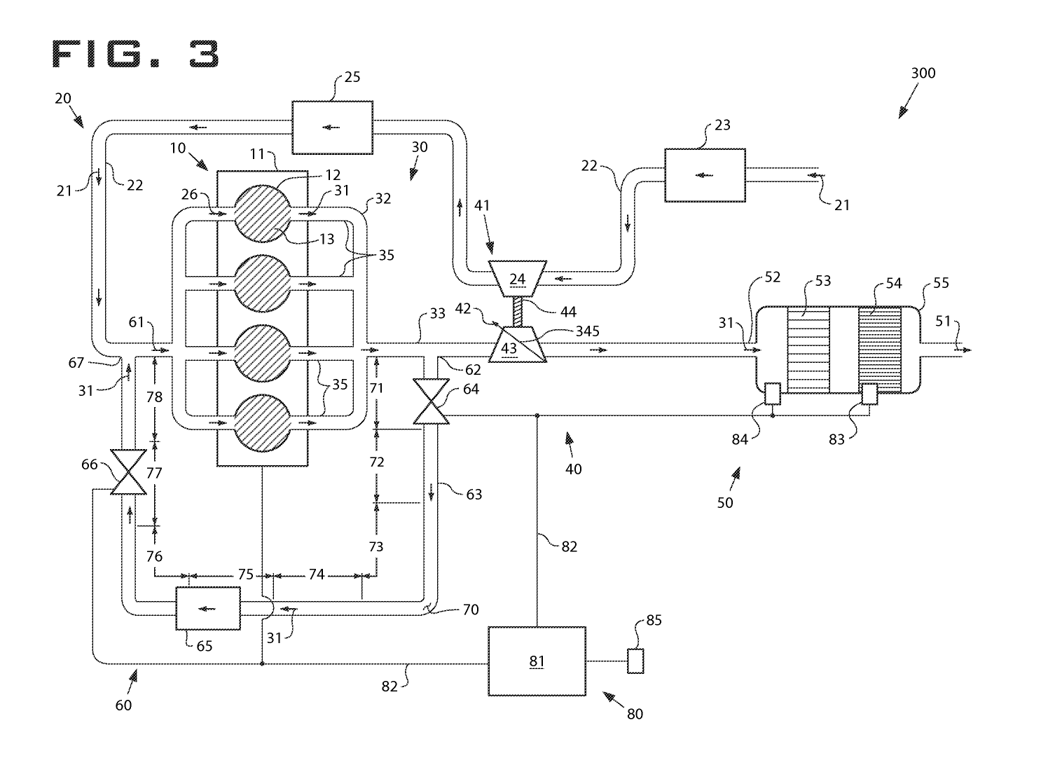

FIG. 3 shows the third power system 300 including a variable geometry turbo 345. The variable geometry turbo 345 may close its vanes, restrict its throat, or otherwise change its configuration to act as the backpressure restriction 42. A downstream backpressure valve may therefore not be needed in power system 300 because of the capabilities of the variable geometry turbo 345. In other embodiments, however, a backpressure valve may still be added to provide additional restriction capabilities.

The aftertreatment system 50 receives raw exhaust 31 and refines it to produce cleaned exhaust 51 that is routed to the atmosphere. Many variations to the aftertreatment system 50 are possible. Described below are a few possible arrangements.

The aftertreatment system 50 includes an exhaust conduit 52, a diesel oxidation catalyst (DOC) 53, and a diesel particulate filter (DPF) 54, which may be a catalyzed DPF 54. The DOC 53 and DPF 54 may be housed in a single canister 55, as shown, or individual canisters. A muffler may also be included in the aftertreatment system 50.

The DOC 53 oxidizes Carbon Monoxide (CO) and unburnt hydrocarbons (HC) into Carbon Dioxide (CO2). The DOC 53 includes a catalyst or precious metal coating on a substrate. The substrate may have a honeycomb or other elongated channel structure or other high surface area configuration. The substrate may be made from cordierite or another suitable ceramic or metal. The precious metal coating may consist mainly of Platinum, though other catalytic coatings may be used. The DOC 53 may also include a washcoat coating to help hold the precious metal coating and provide additional reaction sites.

The DPF 54 collects particulate matter (PM) or soot. The DPF 54 may also include a catalyst or precious metal and washcoat to help the DOC 53 with the oxidization of NO into Nitrogen dioxide (NO2). The catalyst of the DPF 54 is coated on a substrate with a honeycomb or other elongated channel or thin wall structure. The DPF 54 substrate may be more porous than the DOC 53 substrate and every other channel may be blocked with half the channels blocked at the inlet end and half blocked at the outlet end. This increased porosity and the blocked channels encourage wall flow of the exhaust. The wall flow causes the soot to be filtered and collected in the DPF 54.

The aftertreatment system 50 may also include a Selective Catalytic Reduction (SCR) system to reduce NO and NO2 into N2. The SCR system may include a SCR catalyst and reductant system to provide a supply of reductant, such as urea, to the SCR catalyst.

The EGR system 60 routs raw exhaust 31 to the air intake system 20, where the raw exhaust 31 mixes with the fresh air 21 to create a mixed air 61. The mixed air 61 is then delivered to the engine 10. Because the raw exhaust 31 has already been combusted by the engine 10 it contains less oxygen and is more inert than fresh air 21. Therefore the combustion of the mixed air 61 by the engine 10 may generate less heat, which inhibits the formation of NOx.

The EGR system 60 includes an EGR take-off 62, an EGR conduit 63, an upstream EGR restriction 64, an EGR cooler 65, a downstream EGR control valve 66, and an EGR introduction port 67. The EGR conduit 63 routes the exhaust 31 from the exhaust system 30 to the engine 10. The upstream EGR restriction 64, which can be a restriction valve, is upstream from the downstream EGR control valve 66. The upstream EGR restriction 64 and downstream EGR control valve 66 may be disposed in series along a single EGR conduit 63.

The EGR system 60 defines a total EGR volume 70 that represents the total volume of space for the raw exhaust 31 to occupy in the EGR system 60 between the EGR take-off 62 and EGR introduction port 67. The total EGR volume 70 includes the volume of space inside the EGR conduit 63, upstream EGR restriction 64, EGR cooler 65, downstream EGR control valve 66, and any other device in the EGR system 60. The total EGR volume 70 may be divided into eight equal sub-volumes; the first one-eighth EGR volume 71, the second one-eighth EGR volume 72, the third one-eighth EGR volume 73, the fourth one-eighth EGR volume 74, the fifth one-eighth EGR volume 75, the sixth one-eighth EGR volume 76, the seventh one-eighth EGR volume 77, and the eighth one-eighth EGR volume 78.

The EGR take-off 62 diverts the raw exhaust 31 from the exhaust system 30 into the EGR conduit 63 or EGR system 60. FIG. 1 shows the EGR take-off 62 coming off the upstream exhaust manifold 32 in the first power system 100. FIG. 2 shows the EGR take-off 62 coming off the split downstream exhaust manifold 236 that feeds the first volute 246 in the second power system 200. FIG. 3 shows the EGR take-off 62 coming off the downstream exhaust manifold 33 in the third power system 300.

As illustrated, the upstream EGR restriction 64 is located in the first one-eighth EGR volume 71 of the EGR conduit 63. In other embodiments, the upstream EGR restriction 64 may be located in either the first one-fourth EGR volume 71, 72 or in the first one-half EGR volume 71, 72, 73, 74. The upstream EGR restriction 64 may embody a wide range of restrictions. Precise control of the upstream EGR restriction 64 may not be needed. The only control required may be open or closed, so a cheap robust design may be utilized. The upstream EGR restriction 64 may embody a butterfly valve, flapper valve, poppet valve, ball valve, or another restriction. The upstream EGR restriction 64 may be driven hydraulically, electrically, or mechanically.

As illustrated, the downstream EGR control valve 66 is located in the eighth one-eighth EGR volume 78 of the EGR conduit 63. In other embodiments, the downstream EGR control valve 66 may be located in either the fourth one-fourth EGR volume 77, 78 or in the second one-half EGR volume 75, 76, 76, 78. The downstream EGR control valve 66 may embody a wide range of valves. Unlike the upstream EGR restriction 64, precise control of the downstream EGR control valve 66 may be needed to accurately control EGR flow to the engine 10. The downstream EGR control valve 66 may embody a butterfly valve, flapper valve, poppet valve, ball valve, or another restriction. The downstream EGR control valve 66 may be driven hydraulically, electrically, or mechanically.

The EGR cooler 65 may be located anywhere between the EGR take-off 62 and the engine 10. The EGR system 60 may also include a reed valve in the EGR conduit 63. A mixer may also be included at the end of the EGR introduction port 67 to help introduce and mix the raw exhaust 31 with the intake air 21.

The control system 80 receives data from sensors, processes the data, and controls the operation of multiple components in the power system 100, 200, and 300. The control system 80 includes a controller 81, wiring harness 82, and a plurality of sensors. The controller 81 may embody an electronic control module (ECM) or another processor capable of receiving, processing, and communicating the needed data. The controller 81 may also embody multiple units working together. The controller 81 may be in communication with and/or control more or fewer components than is shown in the current embodiments. The controller 81 is configured or programmed to receive data and control the components of the power system 100, 200, and 300 as described herein.

The sensors and components are all connected to the controller 81 via the wiring harness 82. In other embodiments wireless communication may be used instead of the wiring harness 82. The sensors may include a soot loading sensor 83 and an aftertreatment temperature sensor 84. Other sensors may include an air intake temperature sensor, barometric pressure sensor, EGR gas temperature sensor, EGR pressure or flow sensors, other engine 10 related sensors, machine sensors, and many others.

The soot loading sensor 83 provides an indication of the amount of soot loading in the DPF 54. The soot loading sensor 83 may embody a radio frequency (RF) sensor system, pressure sensor system, prediction model, or another method of measuring an amount of soot in the DPF 54.

The aftertreatment temperature sensor 84 provides an indication of the temperature in the aftertreatment system 50. The aftertreatment temperature sensor 84 may embody an aftertreatment inlet temperature sensor, a temperature sensor in another location, an extrapolation from engine 10 maps, infrared temperature sensors, temperature sensors located upstream or downstream, or a correlation from pressure sensors.

The wiring harness 82 is also connected to the engine 10, upstream EGR restriction 64, downstream EGR control valve 66, and may also be connected to an engine braking control 85. The engine braking control 85 is used to command an engine braking operation. The engine braking control 85 may be manual operated or an automatic control that may be integrated into the controller 81.

In power system 100, the wiring harness 82 may also be connected to the backpressure valve 148 and may also be connected to the wastegate valve 147. In power system 200, the wiring harness 82 may also connected to the backpressure valve 248 and may also be connected to the balance valve 239. In power system 300, the wiring harness 82 may also connected to the variable geometry turbo 345. The wiring harness 82 may also be connected to and receive data from and/or control other components in the power systems 100, 200, and 300.

FIG. 4 shows that the engine 10 may include a compression release braking system 400 to act as an engine brake. The compression release braking system 400 is configured to actuate, open, or control the engine's 10 valves. The compression release braking system includes a brake housing, actuators, and other components. The actuators may be actuated via hydraulic forces from pressurized oil or electronically to drive the engine's 10 valves. The compression release braking system 400 may be used in wide variety of power system configurations and is not limited to use in power systems 100, 200, and 300.

### INDUSTRIAL APPLICABILITY

During standard operating modes, the EGR system 60 is used to reduce NOx and other harmful emissions from the engine 10. The amount of EGR needed is determined by the controller 81 given the operating conditions of the engine 10 and the emissions level required. Backpressure downstream of the EGR take-off 62 is used to drive the amount of raw exhaust 31 recirculated back to the engine 10, creating an EGR flow.

Each power system 100, 200, and 300 has different ways to limit or control the backpressure and achieve the amount of EGR flow needed while achieving high efficiency during operation. In power system 100, the backpressure for EGR flow is achieved by sizing the turbine 43 and may also include operating the wastegate valve 147. Power system 100 may also use the backpressure valve 148. In power system 200, the backpressure for EGR flow is achieved by sizing of the first volute 246 smaller than the second volute 247 and may also include closing the balance valve 239. The power system 200 may also use the balance valve 239. In power system 300, the backpressure for EGR flow is achieved by operating the variable geometry turbo 345. Some power systems may also use an intake throttle valve to help drive EGR flow.

During other, non-standard, operating modes, such as engine braking and DPF 54 regeneration, the EGR system 60 may not be needed. Engine braking or retarding is a way of slowing the engine 10 by increasing backpressure or releasing compression pressures on the engine 10.

Regeneration removes or burns the soot that is collected in the DPF 54. Regeneration may be commanded manually or automatically when the soot level measured by the soot loading sensor 83 is above a threshold. The machine may also need to be in an allowable condition for regeneration. This regeneration requires an aftertreatment temperature above a light-off temperature of between 200 and 260 degrees Celsius in the DPF 54. These aftertreatment temperatures may be achieved by increasing backpressure on the engine 10.

Power systems 100, 200, and 300 have different ways of increasing backpressure for engine braking and DPF 54 regeneration. In power systems 100 and 200 the backpressure is increased by closing the backpressure valve 148, 248. In power system 300, the backpressure is increased by operating the variable geometry turbo 345.

Instead of backpressure, the compression release braking system 400 shown in FIG. 4 may be used as the engine brake. The compression release braking system 400 works by actuating, opening, or controlling the engine's 10 valves. The compression release braking system 400 may open or actuate an exhaust valve of the engine 10 near top dead center of the compression stroke, thereby releasing compressed air into the exhaust to dissipate energy and slow the machine. The compression release braking system 400 may replace the backpressure valves 148 and 248 of power systems 100 and 200 if not needed for regeneration of the DPF 54. Unlike the engine braking systems described above, the compression release braking system 400 does not require increasing backpressure on the engine 10, but it still may benefit from the upstream EGR restriction 64.

During backpressure related engine braking and regeneration operations, flow through the EGR system 60 may be stopped. If flow through the EGR system 60 were not stopped the backpressure may drive high levels of EGR and release pressure on the engine 10. Flow through the EGR system 60 could be stopped by the same valve as is used to control the EGR flow—the EGR control valve 66. However, the EGR control valve 66 may need to be downstream in the EGR system 60 to achieve a greater amount of control and accuracy of the EGR flow. The farther upstream the EGR control valve 66 is, the more volume of exhaust 31 will be downstream of the EGR control valve 66. This volume of downstream exhaust 31 would cause operation of the EGR control valve 66 to be less responsive in changing the amount of recirculated exhaust flow 31 that reaches the engine.

However, being further downstream may make the EGR control valve 66 less effective in stopping flow through the EGR system 60 for the braking and regeneration operations. The farther downstream the EGR control valve 66 is, the more volume of exhaust 31 will be upstream of the EGR control valve 66. This volume of upstream exhaust 31 will have to be filled before the maximum backpressure can be achieved for engine braking or DPF 54 regeneration, causing the system to be less responsive and effective.

By adding the upstream EGR restriction 64, flow through the EGR system 60 can be stopped for the engine braking and DPF 54 regeneration operations without needing a large upstream volume of exhaust 31 to be filled. Meanwhile, the EGR control valve 66 can be farther downstream for responsive EGR flow control. Because the upstream EGR restriction 64 only needs to be open or closed it does not need a great deal of variable control or functionality and can be inexpensive.

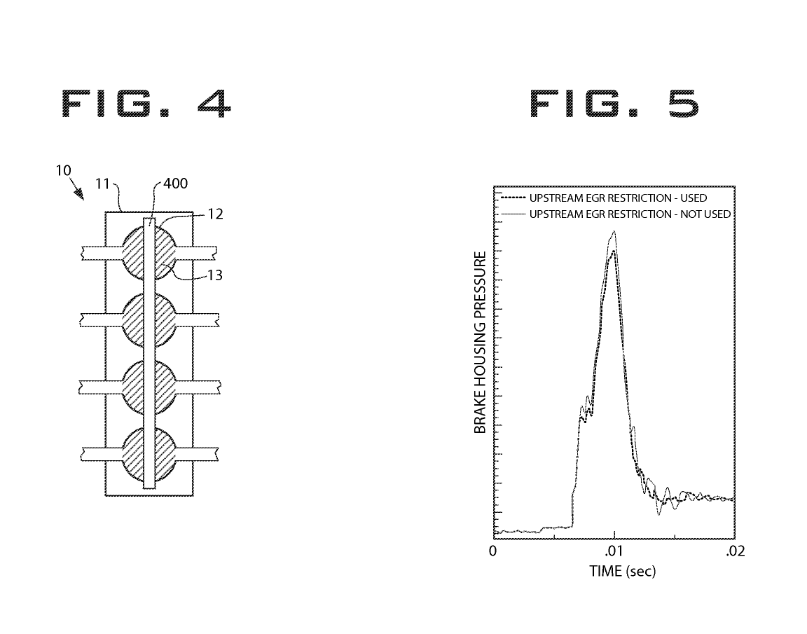

The upstream EGR restriction 64 may also help reduce pressure, load, and stress on the compression release braking system's 400 housing and engine's 10 valves, rocker arms, and injectors when the compression release braking system 400 is used for engine braking. The graph in FIG. 5 illustrates an example of the reduction in pressure on the compression release braking system's 400 housing when the upstream EGR restriction 64 is used compared to when it is not used. This graph was created based on data from a computer simulation with the engine running at 2500 rpm. Brake housing pressure is plotted as a function of time during an activation of the compression release braking system 400. The graph shows reduced peak housing pressure when the upstream EGR restriction 64 is used compared to when the upstream EGR restriction 64 is not used. The graph also shows reduced housing pressure variations when the upstream EGR restriction 64 is used compared to when the upstream EGR restriction 64 is not used.

Tables 1 and 2 below compare additional aspects of the simulated impact when the upstream EGR restriction 64 is used compared to when the upstream EGR restriction 64 is not used.

TABLE 1
Upstream EGR Restriction 64 Is Used

| | |
|---|---|
| BMEP, Total Cycle (kPa): | −1365 |
| Brake Power for All Cylinders (kW): | −433 |
| Intake Flow to All Cylinders (kg/hr): | 2011 |
| Fresh Air Flow (kg/hr): | 1960 |
| High Pressure Loop Flow (small leak)(EGR) (kg/hr): | 51 |
| Ave. Compressor Speed (revs/min): | 87349 |
| Compressor Map Efficiency | 70% |
| Map Pressure Ratio | 2.4 |
| Ave. Turbine Speed (revs/min): | 87349 |
| Turbine Map Efficiency | 64% |
| Map Pressure Ratio | 3.2 |
| Boost Pressure (kPa): | 215 |

TABLE 2
Upstream EGR Restriction 64 Is NOT Used

| | |
|---|---|
| BMEP, Total Cycle (kPa): | −1377 |
| Brake Power for All Cylinders (kW): | −436 |
| Intake Flow to All Cylinders (kg/hr): | 2143 |
| Fresh Air Flow (kg/hr): | 1708 |
| High Pressure Loop Flow (EGR fully open) (kg/hr): | 435 |
| Ave. Compressor Speed (revs/min): | 82881 |
| Compressor Map Efficiency | 77% |
| Map Pressure Ratio | 2.46 |
| Ave. Turbine Speed (revs/min): | 82881 |
| Turbine Map Efficiency | 68% |
| Map Pressure Ratio | 2.6 |
| Boost Pressure (kPa): | 225 |

When flow into the EGR system 60 is allowed during operation of the compression release braking system 400 (the upstream EGR restriction 64 is not used), the turbine 43 efficiency may be higher and the pressure in the exhaust system 30 may build due to turbo 41 restriction leading to higher boost pressures. As a result the cylinder 12 pressures may be higher. To open the engine's 10 exhaust valve against the higher cylinder 12 pressures may cause the compression release braking system's 400 housing pressures to increase. The higher cylinder 12 pressures may also increase the loads on the engine's 10 valves, injectors, and exhaust rocker arms.

Preventing flow into the EGR system 60 during operation of the compression release braking system 400 (the upstream EGR restriction 64 is used) therefore may lower the compression release braking system's 400 housing pressures and may reduce loads on the engine's 10 injector and exhaust rocker arms. Having the EGR restriction 64 far upstream and as close to the turbine inlet as possible, may improve these benefits because less volume of the EGR system 60 has to be filled. Meanwhile, the downstream EGR control valve 66 may provide accurate EGR flow control during standard operating modes.

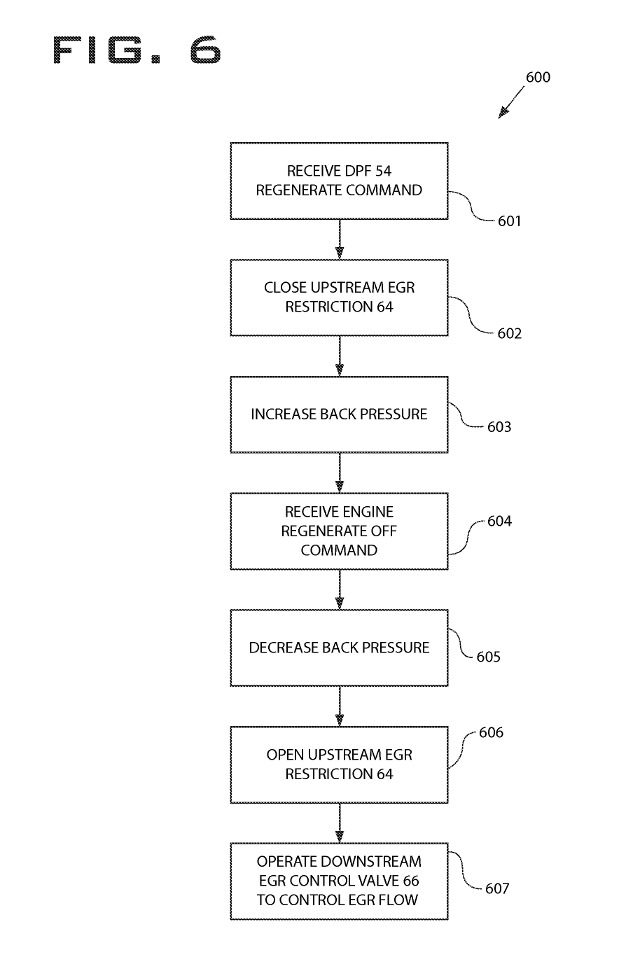

FIG. 6 illustrates a flow diagram of how the regeneration operation 600 may work when utilizing the upstream EGR restriction 64. In step 601 a command for DPF 54 regeneration is received. Next, in step 602, the upstream EGR restriction 64 is closed. Then, in step 603 the backpressure is increased by activating or closing the backpressure restriction 42. The backpressure is raised to the required level to achieve the temperature needed for regeneration. Steps 602 and 603 may be done simultaneously. In step 604, a command for regeneration to stop is received. Next, in step 605, the backpressure is decreased by deactivating or opening the backpressure restriction 42. Then, in step 606 the upstream EGR restriction 64 is again opened. Steps 605 and 606 may be done simultaneously. In step 607 the downstream EGR control valve 66 is again used to control the EGR flow.

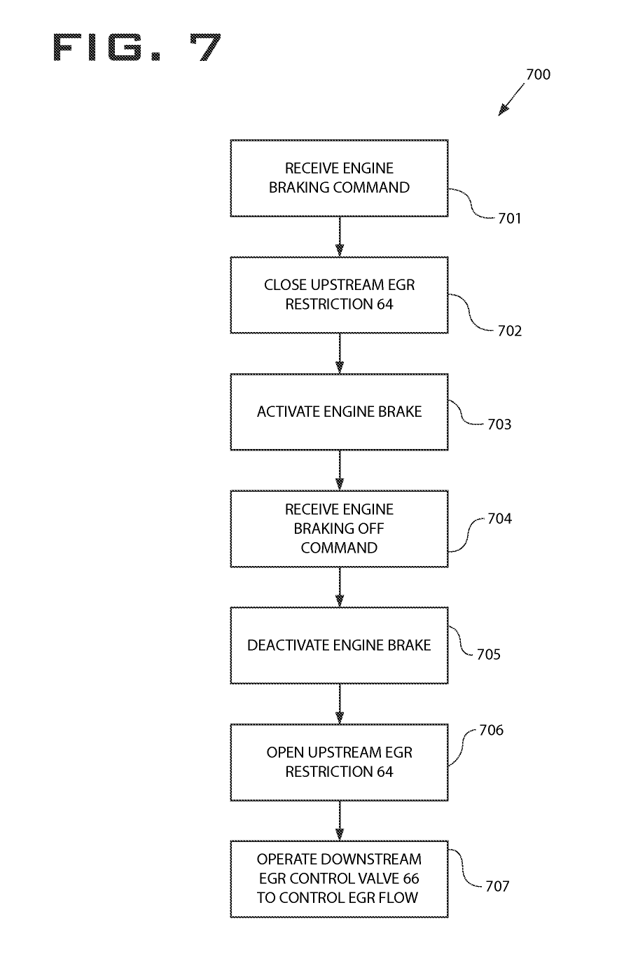

FIG. 7 illustrates a flow diagram of how the engine braking operation 700 may work when utilizing the upstream EGR restriction 64. In step 701 a command for engine braking is received. Next, in step 702, the upstream EGR restriction 64 is closed. Then, in step 703 the engine brake is activated by activating or closing the backpressure restriction 42 or activating the compression release braking system 400. Steps 702 and 703 may be done simultaneously. In step 704, a command to deactivate the engine brake is received. Then, in step 705 the engine brake is deactivated by deactivating or opening the backpressure restriction 42 or deactivating the compression release braking system 400. Then, in step 706 the upstream EGR restriction 64 is again opened. Steps 705 and 706 may be done simultaneously. In step 607 the downstream EGR control valve 66 is again used to control the EGR flow.

The upstream EGR restriction 64 may be used for both the regeneration operation 600 and engine braking operation 700. In other embodiments, the upstream EGR restriction 64 may be used for only the regeneration operation 600. In yet other embodiments, the upstream EGR restriction 64 may be used for only the engine braking operation 700. When used for only the engine braking operation 700 the power system may not even include a DPF 54 requiring regeneration or may include another system to achieve regeneration of the DPF 54; such as cylinder dosing, burners, electrical heating elements, or other heat sources or completely passive systems.

The upstream EGR restriction 64 may also be used during DPF 54 regeneration modes in power systems that use in cylinder dosing. In cylinder dosing introduces unburnt fuel into the raw exhaust 31 to regenerate the DPF 54. This unburnt fuel may harm the EGR cooler 65, but closing the upstream EGR restriction 64 may prevent exposure because the EGR restriction 64 is upstream of the EGR cooler 65. Meanwhile, the EGR control valve 66 can be downstream of the EGR cooler 65 and enjoy the associated cooler temperatures. These cooler temperatures may be more important for the EGR control valve 66 than the EGR restriction 64 because of the EGR control valve's 66 extra sophistication and functionality.

Although the embodiments of this disclosure as described herein may be incorporated without departing from the scope of the following claims, it will be apparent to those skilled in the art that various modifications and variations can be made. Several specific power systems are described above, but the upstream EGR restriction 64 could be utilized in many other power system configurations. The upstream EGR restriction 64 could also be used in other operation modes besides DPF 54 regeneration and engine braking. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A power system comprising:
an engine that produces an exhaust flow; and
an exhaust gas recirculation (EGR) system including:
an EGR conduit routing a portion of the exhaust flow back to the engine;
a restriction valve disposed in the EGR conduit; and
a control valve disposed in the EGR conduit in series with the restriction valve.

2. The power system of claim 1 wherein the restriction valve is located in an upstream one-half volume of the exhaust gas recirculation system.

3. The power system of claim 2 wherein the control valve is located in a downstream one-half volume of the exhaust gas recirculation system.

4. The power system of claim 1 wherein the restriction valve is located in a first one-eighth volume of the exhaust gas recirculation system.

5. The power system of claim 4 wherein the control valve is located in a last one-eighth volume of the exhaust gas recirculation system.

6. The power system of claim 1 further including an EGR cooler located between the restriction valve and the control valve.

7. The power system of claim 1 further including a variable geometry turbine driven by the exhaust flow wherein the restriction valve is closed to prevent the exhaust flow from passing through the EGR conduit when the variable geometry turbine is used for engine braking or to raise the temperature of the exhaust flow for regeneration of an exhaust filter.

8. The power system of claim 1 further including a backpressure restriction in the exhaust wherein the restriction valve is closed to prevent the exhaust flow from passing through the EGR conduit when the backpressure restriction is used for engine braking or to raise the temperature of the exhaust flow for regeneration of an exhaust filter.

9. The power system of claim 1 further including a compression release braking system that actuates an exhaust valve of the engine near top dead center of a compression stroke wherein the restriction valve is closed to prevent the exhaust flow from passing through the EGR conduit when the compression release braking system is used for engine braking.

10. A method of operating a power system comprising:
actuating a control valve disposed in an exhaust gas recirculation (EGR) conduit that routes an exhaust flow from an engine back to the engine during a standard operating mode; and
actuating a restriction valve disposed in the EGR conduit upstream of the control valve to stop the flow through the EGR conduit during engine braking.

11. The method of claim 10 wherein the control valve and restriction valve are in series in the EGR conduit.

12. The method of claim 10 wherein the engine braking is achieved by a actuating an exhaust valve of the engine near top dead center of a compression stroke.

13. The method of claim 10 wherein the engine braking is achieved by applying a backpressure restriction downstream of the engine.

14. The method of claim 10 wherein the restriction valve is located in an upstream one-half volume of the exhaust gas recirculation system.

15. The method of claim 14 wherein the control valve is located in a downstream one-half volume of the exhaust gas recirculation system.

16. A method of operating a power system comprising:
actuating a control valve disposed in an exhaust gas recirculation (EGR) conduit that routes an exhaust flow from an engine back to the engine during a standard operating mode; and
actuating a restriction valve disposed in the EGR conduit upstream of the control valve to stop the flow through the EGR conduit during regeneration of an exhaust filter.

17. The method of claim 16 wherein the control valve and restriction valve are in series in the EGR conduit.

18. The method of claim 16 wherein the regeneration of the exhaust filter is achieved by applying a backpressure restriction downstream of the engine.

19. The method of claim 16 wherein the restriction valve is located in an upstream one-half volume of the exhaust gas recirculation system.

20. The method of claim 19 wherein the control valve is located in a downstream one-half volume of the exhaust gas recirculation system.
